(19) United States
(12) Patent Application Publication
(10) Pub. No.: US 2014/0277953 A1
(43) Pub. Date: Sep. 18, 2014

(54) SEAT SLIDE APPARATUS FOR VEHICLE

(71) Applicant: AISIN SEIKI KABUSHIKI KAISHA, Kariya-shi, Aichi-ken (JP)

(72) Inventors: Soichiro Hozumi, Nishio-shi (JP); Hitoshi Takayanagi, Kariya-shi (JP); Toshiro Maeda, Anjo-shi (JP)

(73) Assignee: AISIN SEIKI KABUSHIKI KAISHA, Kariya-shi, Aichi-ken (JP)

(21) Appl. No.: 14/353,347

(22) PCT Filed: Nov. 28, 2012
(86) PCT No.: PCT/JP2012/080671

§ 371 Date: Apr. 22, 2014

(30) Foreign Application Priority Data
Dec. 9, 2011 (JP) 2011-270411

(51) Int. Cl. B60N 2/08

(52) U.S. Cl. CPC B60N 2/08
USPC 701/49

(57) ABSTRACT

A seat slide apparatus includes a lock device, which is switchable between locked and released states, and a control device, which controls the operation of the lock device. The control device includes a manipulation detection portion, a first control portion, which switches the lock device to the released state in response to the detection of the manipulation and switches the lock device to the locked state in response to the stoppage of the detection of the manipulation, a door opening-and-closing detection portion, which detects opening and closing of the vehicle door, and a second control portion. The second control portion determines whether a door open-time release condition under, which the movement of the vehicle seat should be permitted is satisfied when opening the vehicle door, and switches the lock device to the released state and maintains the released state if the door open-time release condition is satisfied.

### TECHNICAL FIELD

The present invention relates to a seat slide apparatus for a vehicle.

### BACKGROUND ART

Conventionally, the seat slide apparatus including a lock device, which is switchable between a locked state (seat slide lock) and a released state by a drive source, is publicly known. For example, the lock device disclosed in Patent Document 1 is usually held in the locked state by an elastic force of a spring. The lock device is switched from the locked state to the released state and the released state can be maintained.

That is, the lock device including such a drive source facilitates the release of the seat slide apparatus. Also, an operation switch (release request switch) can be provided at any position. For example, the operation switch is provided on a seat back. This allows an occupant on a rear seat to move front seats (mainly, a front passenger seat). This improves a convenience of an occupant. For example, this allows the occupant to exit and enter (walk-in) the vehicle through each rear door (rear door opening).

However, when the operation switch is provided at a position in which the switch can be easily operated by the occupant, erroneous operations in the state where the release of the seat slide apparatus is not needed, or in the state in which the seat slide apparatus should not be released may be performed. Accordingly, as for such an additionally provided operation switch, the released state of the lock device is maintained as long as the operation switch is operated, that is, the operation continues. Therefore, it is common to adopt a configuration in which the safety is improved by avoiding the situation in which the released state continues due to the erroneous input or fault recognition.

### PRIOR ART DOCUMENT

### Patent Document

Patent Document 1: Japanese Laid-Open Patent Publication No. 2005-206154

### SUMMARY OF THE INVENTION

### Problems that the Invention is to Solve

However, since such a continuous operation is needed, there is a problem that the advantage that the seat slide apparatus can be released by the drive source is not sufficiently taken. For example, in the case where the occupant having baggage in his/her hands enters the vehicle through the rear door, it is convenient if the lock of the seat slide apparatus of the front seat can be released at one touch of the switch. However, in the above conventional technologies, an operation in which the occupant continues pulling an operation lever for releasing a lock is needed. Accordingly, finally, the occupant is often forced to put down the baggage to operate the operation lever. There is a room for improvement in this regard.

An objective of the present invention is to provide a seat slide apparatus for a vehicle, which prevents the situation in which the released state of the lock device continues on the basis of an erroneous input and a fault recognition from occurring, and further improves the convenience.

### Means for Solving the Problems

To achieve the above described object, a seat slide apparatus for a vehicle including a lock device and a control device is provided. The lock device is switchable, by a drive source, between a locked state in which movement of a vehicle seat is limited and a released state in which movement of the vehicle seat is permitted. The control device controls operation of the lock device. The control device includes an operation detection portion, a first control portion, a door opening-and-closing detection portion, and a second control portion. The operation detection portion detects a manipulation performed on a manipulation switch provided on the vehicle seat. The first control portion switches the lock device to the released state in response to a detection of the manipulation, and switches the lock device to the locked state in response to a stoppage of the detection of the manipulation. The door opening-and-closing detection portion detects opening and closing of a vehicle door. The second control portion determines, at an opening of the vehicle door, whether a door open-time release condition under, which movement of the vehicle seat should be permitted, is satisfied, and switches the lock device to the released state and maintains the released state if the door open-time release condition is satisfied.

According to the above configuration, the lock device is switched to the released state and the released state is maintained in the limited situation in which it is considered that movement of the seat should be permitted when opening the vehicle door. This prevents the situation in which the released state continues due to an erroneous input and a fault recognition from occurring, and improves the convenience when an occupant enters the vehicle.

In the case where the present invention is applied to the front passenger seat of the vehicle, for example, when an occupant enters the vehicle through the rear door (rear door opening), the seat slide lock of the front passenger seat is released on the basis of the fact that the door open-time release condition is satisfied. The released state is maintained without requiring the continuous operation of the operation switch. This facilitates the occupant to exit and enter the vehicle even if he/she has baggage in his/her hands.

### BRIEF DESCRIPTION OF THE DRAWINGS

FIG. 1 is a schematic diagram illustrating a seat slide apparatus for a vehicle according to one embodiment of the present invention;

FIG. 2 is a diagram illustrating a change of locked and released states;

FIG. 3 is a schematic diagram illustrating a vehicle including the seat slide apparatus for a vehicle;

FIG. 4 is a flowchart showing a process of determining a door open-time release condition;

FIG. 5 is a flowchart showing a process of determining an end condition;

FIG. 6 is a flowchart showing a process of determining an inhibiting condition;

FIG. 7 is a flowchart showing a process of a release control and a lock control;

FIG. 8 is a flowchart illustrating a process of determining a door open-time release condition according to another embodiment; and

FIG. 9 is a flowchart illustrating a process of determining a door open-time release condition according to another embodiment.

### MODES FOR CARRYING OUT THE INVENTION

Hereafter, a seat slide apparatus for a vehicle according to one embodiment of the present invention will be described with reference to the accompanying drawings.

As shown in FIG. 1, a seat 1 for a vehicle includes a seat cushion 2, a seat back 3 supported by a rear end portion of the seat cushion 2 so that the seat back 3 can tilt, and a head rest 4 provided on the upper end of the seat back 3.

Two lower rails 5 arranged in parallel are provided on a floor F of the vehicle. Two upper rails 6 are mounted on the lower rails 5, such that each upper rail 6 slides on the corresponding lower rail 5. The seat cushion 2 of the seat 1 is fixed onto the upper rails 6.

That is, in the present embodiment, the seat slide apparatus 10 for a vehicle is formed by the lower rails 5 and the upper rails 6. An occupant of the vehicle adjusts the position of the seat 1 in the vehicle front-back direction (right-left direction in FIG. 1) by using a function of the seat slide apparatus 10 for a vehicle.

The seat slide apparatus 10 for a vehicle according to the present embodiment includes a lock device 12 and an electronic control unit (ECU) 13. The lock device 12 is switchable between a locked state (seat slide lock) and a released state (release of the seat slide lock) with a motor 11, which serves as a drive source. The ECU 13 serves as a control device for controlling the operation of the lock device 12. In the locked state, movement of the seat 1 is limited, and in the released state, movement of the seat 1 is permitted.

The lock device 12 of the present embodiment includes a publicly-known lock mechanism (not shown), which limits the movement of the seat 1 by inserting a lock claw provided on the seat 1 into an engagement hole formed in each lower rail 5. The locked state and the released state can be switched by operating the lock claw according to the driving force of the motor 11.

Operation switches 15 used when the occupant performs a switching operation between the locked state and the released state are connected to the ECU 13. Specifically, the operation switches 15 include a seat side release request switch 15A provided on a side surface (seat side) of the seat cushion 2, and a seat back release request switch 15B provided on a rear face of the seat back 3, which are connected to the ECU 13. That is, in the present embodiment, an operation detection portion is configured by the ECU 13.

As shown in FIG. 2, the ECU 13 according to the present embodiment controls the lock device 12 to switch the lock device 12 to a released state α in response to the operation of each operation switch 15 (release request switch SW=ON). In contrast, the ECU 13 controls the lock device 12 to switch the lock device 12 to a locked state β in response to the stoppage of the operation (release request switch SW=OFF).

More specifically, as shown in FIG. 1, a release limit switch 16 is connected to the ECU 13. The release limit switch 16 is turned ON when the lock device 12 is changed to a completely released state (completion of disengagement of the lock claw). Also, a lock position limit switch 17 is connected to the ECU 13. The lock position limit switch 17 is turned ON when the lock device 12 is changed to a completely locked state (completion of insertion of the lock claw).

As shown in FIG. 2, the ECU 13 stops driving of the motor 11 when the release limit switch 16 is set as ON in the release control. This changes the lock device 12 from a release operation state α1 to a release maintaining state α0.

Further, the lock position limit switch 17 is set as ON in the lock control, and the ECU 13 stops the driving of the motor 11. This changes the lock device 12 from a locking operation state β1 to a lock position maintaining state β0.

As shown in FIG. 3, the seat slide apparatus 10 for a vehicle of the present embodiment is applied to a front passenger seat 21 of a vehicle 20, for example. This allows the occupant of the vehicle 20 to operate the seat back release request switch 15B to release the seat slide lock of the front passenger seat 21 when the occupant enters the vehicle 20 through a rear door opening 23, which is open to a side of a rear seat 22 (lower portion in FIG. 3). Further, in the vehicle 20, a slide door 24 is provided in the rear door opening 23. The slide door 24 moves in the vehicle front-back direction (in the right-left direction in FIG. 3) to selectively open and close the rear door opening 23. The front passenger seat 21 is moved forward to facilitate the occupant to enter and exit a driver seat 25 using the rear door opening 23, for example. This improves the convenience of the vehicle 20.

As shown in FIG. 1, a slide door opening-and-closing sensor 31, which detects opening and closing of the slide door 24, is connected to the ECU 13. That is, in the present embodiment, a door opening-and-closing detection portion is configured by the ECU 13. Various information, i.e., signals for detecting the riding condition of the occupant in the vehicle 20 and the traveling state of the vehicle are supplied from a plurality of sensors and switches including the slide door opening-and-closing sensor 31 to the ECU 13.

As shown in FIG. 3, specifically, the vehicle 20 includes a front passenger seat door opening-and-closing sensor 33, which detects opening and closing of a front passenger seat door 32 on the side of the front passenger seat 21, and an occupant detection sensor 34, which detects a seating condition of the occupant on the front passenger seat 21. A foot detection sensor 35, which detects an approach of the foot of the occupant, is provided below the rear door opening 23. The foot detection sensor 35 is configured by a publicly-known capacitive sensor. As shown in FIG. 1, the sensors 31, 33, 34, and 35 are connected to the ECU 13.

An electronic key system, which locks and unlocks the vehicle doors (including the slide door 24) using a mobile device 36 (FIG. 3), is mounted on the vehicle 20. The ECU 13 is connected to an authorizing ECU 37, which serves as a control portion of the electric key system, via a vehicle network (not shown).

As shown in FIG. 3, the mobile device 36 of the present embodiment includes a mobile device release request switch 15C, which serves as a second operation switch used when the occupant performs the seat slide lock and the release of the front passenger seat 21. The ECU 13, which serves as a second operation detection portion, detects the operation of the mobile device release request switch 15C on the basis of communication with the above authorizing ECU 37.

As shown in FIG. 1, the ECU 13 is connected to a shift device 38, which controls a gearbox (not shown) of the vehicle. Through connection with the shift device 38, the ECU 13 can obtain information regarding the control state of the gearbox including shift positions such as P, R, N, and D, i.e., the traveling state of the vehicle.

The ECU 13 of the present embodiment determines whether movement of the front passenger seat 21 should be permitted when opening the slide door 24, that is, whether the lock device 12 of the seat slide apparatus 10 for a vehicle should be switched to the released state on the basis of the information. The ECU 13 controls the operation of the lock device 12 on the basis of the determination result.

That is, as shown in FIG. 2, the ECU 13 switches the lock device 12 to the released state a according to the opening operation of the slide door 24 and the satisfaction of a predetermined release condition as well as the normal release control (first control portion) as described above on the basis of the operation of the operation switch 15 provided on the front passenger seat 21. When the ECU 13 switches the lock device 12 to the released state a according to the satisfaction of the door-open time release condition, the ECU 13 maintains the released state a until a preset end condition is satisfied (second control portion).

In more details, as shown in the flowchart of FIG. 4, when the ECU 13 detects the opening operation of the slide door 24, the ECU 13 determines whether the operation of the operation switch 15 provided on the seat 1, i.e., the front passenger seat 21 is performed, more specifically, whether the seat back release request switch 15B is ON (step S101). Further, the ECU 13 determines whether the operation of the second operation switch provided on the mobile device 36 (refer to FIG. 3) is performed, that is, whether the mobile device release request switch 15C is turned ON (step S102). Moreover, the ECU 13 determines whether it is detected that the foot of the occupant approaches the foot detection sensor 35 provided on the lower portion of the rear door opening 23 (step S103). If at least any one of the release conditions is satisfied (the door open-time release condition is satisfied in step S104), the ECU 13 controls the lock device 12 to switch it to the released state. If any of the release conditions is not satisfied (door-open time release condition is not satisfied in step S105), the lock device 12 is held in the locked state.

As shown in the flowchart of FIG. 5, after the ECU 13 switches the lock device 12 to the released state (refer to FIG. 2, more specifically, after the lock device 12 is switched to the release maintaining state α0), it is determined whether the closing operation of the slide door 24 is detected as an end condition in which the maintaining of the released state should be terminated (step S201). Further, the ECU 13 determines whether a predetermined time since the release has elapsed (step S202), and whether the vehicle 20 is in the travelable state (step S203). If the parking lock of the gearbox is released (if the shift position other than the P range is selected), the ECU 13 of the present embodiment determines that the vehicle 20 is in the travelable state. If any of the end conditions is not satisfied (the end condition is not satisfied in step S204), the ECU 13 maintains the released state. If at least any one of the end conditions is satisfied (the end condition is satisfied in step S205), the ECU 13 controls the lock device 12 to switch it to the locked state.

Further, as shown in the flowchart of FIG. 6, the ECU 13 determines whether the occupant is seated on the front passenger seat 21 (step S301), whether the front passenger seat door 32 is open (step S302), and whether the vehicle 20 is in the travelable state (step S303) as inhibiting conditions of the release control. The ECU 13 performs the release control only if neither of the end conditions is satisfied (inhibiting condition is not satisfied in step S304). If at least any one of the inhibiting conditions is satisfied (inhibiting condition is satisfied in step S305), the ECU 13 does not perform the release control.

That is, in the case where, when entering the vehicle 20 through the rear door opening 23, the occupant operates the seat back release request switch 15B so that the seat slide lock of the front passenger seat 21 is released, it is desirable that the released state continues in most cases. Regarding methods other than the method of operating the operation switch 15 provided on the seat 1, specifically, in the case where the release request is generated by the mobile device release request switch 15C or the foot detection sensor 35, for example, the situation is likely to be caused in which it is difficult for the occupant to continue to operate the seat back release request switch 15B since the occupant holds the baggage in his/her hands. That is, it is presumed that it is highly demanded to maintain the released state. Therefore, in this case, it is also considered that it is preferable that the released state continues.

In the present embodiment, the door open-time release condition (refer to FIG. 4) is set in accordance with the situations. If the door open-time release condition is satisfied, the lock device 12 is held in the released state according to the advantage that the release can be performed by driving the motor. This improves the convenience of the occupant for entering the vehicle through the rear door opening 23 provided with the slide door 24. The release and the maintaining of the released state are performed in a limited manner so that the occurrence of the situation in which the released state continues due to the erroneous input and the erroneous recognition is limited.

However, when the occupant is seated on the front passenger seat 21, or about to exit or enter the vehicle, or when the vehicle is running, it is not considered that the release by the operation of the occupants other than the occupant on the front passenger seat 21 is preferable. In the present embodiment, the above inhibiting condition (refer to FIG. 6) is set in accordance with the situations. This improves the convenience and the safety of the occupants of the vehicle 20 including the occupants that do not exit or enter the vehicle 20 through the rear door opening 23.

Further, in consideration of the fact that the seat slide apparatus 10 for a vehicle according to the present embodiment is used for the seat 1 for a vehicle, which should be fixed onto the floor F at a certain position, it is not considered that it is preferable that the released state unconditionally continues even if the convenience is improved. In the present embodiment, the above end conditions (refer to FIG. 5) are set in accordance with the situations. Accordingly, the lock device 12 is automatically locked to achieve higher safety.

Next, the steps of the process of the release and the lock control in the present embodiment will be described.

As shown in the flowchart of FIG. 7, the ECU 13 performs an inhibiting condition determination (refer to FIG. 6) (step S401), and if the inhibiting condition is not satisfied (i.e., NO in step S402), the ECU 13 determines whether the opening operation of slide door 24 is detected (step S403).

If the opening operation of the slide door 24 is detected in step S403 (i.e., YES in step S403), the ECU 13 then performs the door open-time release condition determination (refer to FIG. 4) (step S404). If the door open-time release condition is satisfied (i.e., YES in step S405), the ECU 13 controls the lock device 12 to be in the released state (release control in step S406).

After the ECU 13 starts the release control in step S406, the ECU 13 performs the end condition determination (refer to FIG. 5) (step S407). If the end condition is not satisfied (i.e., NO in step S408), the process in above steps S406 and S407 is repeated to continue the release control. If the end condition is satisfied (i.e., YES in step S408), the lock device 12 is controlled to be locked (lock control in step S409).

In step S403, if the opening operation of the slide door 24 is not detected (i.e., NO in step S403), the ECU 13 then determines whether the seat side release request switch 15A or the seat back release request switch 15B is ON (step S410). If any of the release request switches (15A, 15B) is ON (i.e., YES in step S410), that is, if the operation of the operation switch 15 provided on the seat 1 is performed, the lock device 12 is controlled to be in the released state (release control in step S411).

After starting the release control in step S411, the ECU 13 determines whether the operation of the operation switch 15 has stopped. That is, the ECU 13 determines whether the release request switch, which was ON in above step S410, is turned OFF (step S412). If the release request switch continues to be ON (i.e., NO in step S412), the release control continues by repeating the process in above steps S411 and step S412. If the release request switch is turned OFF (i.e., YES in step S412), the ECU 13 controls the lock device 12 to switch it to the locked state (lock control in step S413).

The ECU 13 of the present embodiment performs the process shown in each of above steps S401 to S413 at preset timing. If the door open-time release condition is not satisfied in above step S405 (i.e., NO in step S405), the ECU 13 does not perform the process in step S406 and the subsequent steps. If both of the release request switches (15A, 15B) are OFF in above step S410 (i.e., NO in step S410), the ECU 13 does not perform the process in step S411 and the subsequent steps. When the inhibiting condition is satisfied in above step S402 (i.e., YES in step S402), the ECU 13 does not perform the process in step S403 and the subsequent steps.

That is, in the present embodiment, the ECU 13, which performs the process in each of above steps S410 to S413, configures a first control portion. Further, the ECU 13, which performs the process in each of above steps S403 to 5409, configures a second control portion. The process in each of steps S401 and S402 configures an inhibiting portion.

As mentioned above, the present embodiment has the following advantages.

(1) The ECU 13 determines whether movement of the front passenger seat 21 should be permitted when opening the slide door 24, that is, whether the lock device 12 of the seat slide apparatus 10 for a vehicle should be switched to the released state. If the door open-time release condition is satisfied, the ECU 13 switches the lock device 12 to the released state, and maintains the released state.

Accordingly, the lock device 12 is switched to the released state and the released state is maintained limited to the situation in which it is considered that the movement of the front passenger seat 21 should be permitted in the opening operation of the slide door 24. As a result, the convenience of the occupant for entering the vehicle through the rear door opening 23 is improved, while limiting the occurrence of the situation in which the released state continues due to an erroneous input or an erroneous recognition.

(2) The ECU 13 maintains the released state of the lock device 12 until the preset end condition is satisfied. That is, in consideration of the fact that the seat slide apparatus 10 for a vehicle is used for the seat 1 for a vehicle, which should be fixed onto the floor F at a certain position, it is not considered that it is preferable that the released state unconditionally continues even if the convenience is improved. Accordingly, if the above end condition is satisfied, the lock device 12 is automatically switched to the locked state so that the higher safety is obtained.

(3) If the preset inhibiting condition is satisfied, the ECU 13 does not switch the lock device 12 to the released state. For example, there is a situation in which it is not considered that the seat slide lock should be released in such a case where it is not preferable that the seat slide lock is released by the occupants other than the occupant on the front passenger seat 21. Accordingly, such a situation is set as the inhibiting condition to improve the convenience and the safety of the occupants of the vehicle 20 including the occupants that do not exit and enter the vehicle 20 through the rear door opening 23.

The above described embodiment may be modified as follows.

In the above embodiment of the present invention, the seat slide apparatus 10 for a vehicle is applied to the front passenger seat 21 in the vehicle 20 in which the slide door 24 is provided in the rear door opening 23 (refer to FIG. 3). However, the present invention is not limited to this. According to the embodiment of the present invention, the seat slide apparatus for a vehicle may be applied to the driver seat 25. If a rearmost seat 39 is arranged behind the rear seat 22 (second row seat), the seat slide apparatus for a vehicle according to the embodiment of the present invention may be applied to the rear seat 22.

That is, the seat slide apparatus for a vehicle of the present invention may be applied to a seat in which the convenience is improved by adjusting the position of the seat when the occupant exits or enters the vehicle through any of the vehicle doors. Therefore, the opening and closing of a door other than the slide door 24 of the rear door opening 23 may be detected. The form of the vehicle door is not limited to the slide door. It may be an ordinary door, which pivots about a support portion (hinge), or a flip-up door. Although this is not referred to in the above embodiment, the slide door 24 may be a power door including a drive source, or may be opened using gravity or a spring.

In the above embodiment, FIG. 3 shows the vehicle 20 including the third row rearmost seat 39, the rear door opening 23, and the slide door 24. However, the configuration of the vehicle 20 is not limited to this. For example, the vehicle 20 may be configured such that it does not include any of the third row rearmost seat 39, the rear door opening 23, and the slide door 24. The seat slide apparatus for a vehicle according to the present invention may be applied to a vehicle including right and left doors, i.e., total of two doors provided on the sides of the vehicle body, for example. Even if the seat slide apparatus is applied to such a vehicle, the advantages that facilitate exiting and entering the vehicle to a seat opposite to the opened door are also obtained.

In the above embodiment, the seat side release request switch 15A and the seat back release request switch 15B are provided on the seat 1 as the operation switch 15. The operation switch 15 may be provided at a position other than the seat sides and the rear surface of the seat back 3. The door open-time release condition determination may be performed on the basis of the operations of the switches including the operation switch 15 other than the seat back release request switch 15B.

In the above embodiment, the door open-time release condition determination regarding the front passenger seat 21 is performed on the basis of the opening operation of the slide door 24. The present invention is not limited to this. The door-open time release condition determination may be performed even when the opening operations of the vehicle doors other than the slide door 24 are performed (for example, by presuming that the slide door 24 will be opened soon).

In the above embodiment, the door open-time release condition determination is performed when the opening operation of the slide door 24 is detected. The present invention is not limited to this. If it is presumable that the vehicle door is opened, for example, when the operation of the mobile device release request switch 15C and a special operation by the foot detection sensor 35 are detected, or when the slide door 24 is a power door, which can be opened and closed by a drive source, the door open-time release condition determination may be performed before the opening operation. In this case, the seat slide lock may be released before the opening operation of the vehicle door.

In the same manner as the seat back release request switch 15B, the door open-time release condition determination may also be performed when the vehicle door is opened after the detection of the operation of the operation switch 15 provided on the seat 1. That is, any one of the two conditions “the opening operation of the vehicle door” and “the operation” configuring the door open-time release condition may occur first. For this reason, for example, when the occupant in the passenger compartment releases seat slide lock of the front passenger seat 21 before the slide door is opened, the released state is also maintained. This further improves the convenience.

In the same manner, the operation of the mobile device release request switch 15C, which serves as a second operation switch, may also be detected before and after the opening operation of the slide door 24. The approach of the foot of the occupant may also be detected by the foot detection sensor 35 before and after the opening operation of the slide door 24.

In the above embodiment, as the door open-time release condition determination, it is determined whether the approach of the foot of the occupant is detected by the foot detection sensor 35 provided on the lower portion of the rear door opening 23. However, the present invention is not limited to this. The operations according to other methods may be defined as the door open-time release condition as long as the operations correspond to the special operation that is presumed to permit movement of the front passenger seat 21.

In the case of the power door, which can be opened and closed by the drive source, the vehicle door may be automatically opened by the special operation. In this case, it may be regarded that the special operation that is presumed to permit the movement of the front passenger seat 21 occurs by performing a special control to automatically open the vehicle door.

Although this is not specifically referred to in the above embodiment, as shown in the flowchart of FIG. 8, if the operation of the seat back release request switch 15B is detected (the seat back release request switch 15B is ON) within a predetermined time period since the opening operation of the slide door 24 (i.e., YES in step S501 and YES in step S502), it may be determined that the door open-time release condition is satisfied (step S503).

Further, as shown in the flowchart of FIG. 9, if the operation of the seat back release request switch 15B is detected (the seat back release request switch 15B is ON, i.e., YES in step S601, and the slide door 24 is in the open state, i.e., YES in step S602) when the slide door 24 is open, it may be determined that the door open-time release condition is satisfied (step S603). In this case, the operation when the door open-time release condition is not satisfied (steps S504 and S604) is the same as that in the above embodiment (refer to FIG. 4, step S105).

Such a configuration more advantageously limits the occurrence of the situation in which the released state continues due to an erroneous input or an erroneous recognition.

It may be determined that the door open-time release condition is satisfied according to the opening operation of the slide door 24. In this case, the seat slide lock may be automatically released and the released state may be maintained. Such a configuration also improves the convenience when the occupant enters the vehicle through the rear door opening 23.

In the above embodiment, the mobile device release request switch 15C, which serves as a second operation switch, is provided on the mobile device 36, which selectively locks and unlocks the vehicle door. However, the present invention is not limited to this. The second operation switch may be operated outside the vehicle, and provided on a door handle or a door panel, for example. That is, if the release request has already been generated when the occupant is outside the vehicle, the request for maintaining the released state is highly presumed. Such a configuration further improves the convenience when the occupant enters the vehicle.

The door open-time release condition, the end condition, and the inhibiting condition are not limited to those in the above embodiment. They may be appropriately set in accordance with the characteristics of the vehicle.

1. A seat slide apparatus for a vehicle, comprising:
a lock device, which is switchable, by a drive source, between a locked state in which movement of a vehicle seat is limited and a released state in which movement of the vehicle seat is permitted; and
a control device, which controls operation of the lock device, wherein the control device includes
an operation detection portion, which detects a manipulation performed on a manipulation switch provided on the vehicle seat,
a first control portion, which switches the lock device to the released state in response to a detection of the manipulation, and switches the lock device to the locked state in response to a stoppage of the detection of the manipulation,
a door opening-and-closing detection portion, which detects opening and closing of a vehicle door, and
a second control portion, which determines, at an opening of the vehicle door, whether a door open-time release condition under, which movement of the vehicle seat should be permitted, is satisfied, and switches the lock device to the released state and maintains the released state if the door open-time release condition is satisfied.

2. The seat slide apparatus for a vehicle according to claim 1, wherein the second control portion switches the lock device to the released state if the door opening-and-closing detection portion detects an opening of the vehicle door and the manipulation detection portion detects the manipulation.

3. The seat slide apparatus for a vehicle according to claim 2, wherein the second control portion switches the lock device to the released state if the manipulation detection portion detects the manipulation within a predetermined time period since the opening of the vehicle door.

4. The seat slide apparatus for a vehicle according to claim 1, wherein the second control portion switches the lock device to the released state if the manipulation detection portion detects the manipulation when the vehicle door is open.

5. The seat slide apparatus for a vehicle according to claim 1, wherein
the control device includes a second manipulation detection portion, which detects a manipulation of a second manipulation switch, which is operable outside the vehicle, and
the second control portion switches the lock device to the released state if the opening operation of the vehicle door is performed and the second manipulation detection portion detects the manipulation of the second manipulation switch.

6. The seat slide apparatus for a vehicle according to claim 5, wherein the second manipulation switch is provided on the vehicle door, or in a mobile device used for locking and unlocking the vehicle door.

7. The vehicle seat sliding apparatus for a vehicle according to claim 1, wherein the second control portion releases the lock device if the opening operation of the vehicle door is performed and it is determined that a preset special manipulation in which it is presumed that movement of the vehicle seat should be permitted is performed.

8. The seat slide apparatus for a vehicle according to claim 1, wherein the second control portion releases the lock device if the door opening-and-closing detection portion detects the opening of the vehicle door.

9. The seat slide apparatus for a vehicle according to claim 1, wherein the second control portion maintains the released state of the lock device until a preset end condition is satisfied.

10. The seat slide apparatus for a vehicle according to claim 1, wherein the control device includes an inhibiting portion, which inhibits the release of the lock device if a preset inhibiting condition is satisfied.

11. The seat slide apparatus for a vehicle according to claim 10, wherein the inhibiting portion inhibits switching of the lock device to the released state if the inhibiting condition based on at least one of a state of the vehicle door, a seated state on the vehicle seat, and a traveling state of the vehicle is satisfied.

12. The seat slide apparatus for a vehicle according to claim 1, wherein the second control portion terminates the maintaining of the released state if the end condition based on at least one of closing of the vehicle door, elapsed time since the release, and a traveling state of the vehicle is satisfied.
